(19) United States
(12) Patent Application Publication
(10) Pub. No.: US 2010/0167785 A1
(43) Pub. Date: Jul. 1, 2010

(54) CELL PHONE

(76) Inventors: Chen-Chen LIU, Taipei County (TW); Ting Ru Chen, Taipei County (TW)

Correspondence Address: Muncy, Geissler, Olds & Lowe, PLLC, 4000 Legato Road, Suite 310, FAIRFAX, VA, 22033, US

(21) Appl. No.: 12/647,190

(22) Filed: Dec. 24, 2009

(30) Foreign Application Priority Data
Dec. 26, 2008 (TW) 097223400

(51) Int. Cl. H04M 1/00; H04B 1/38; H04W 88/02

(52) U.S. Cl. 455/556.1; 455/567; 455/572; 455/575.1

(57) ABSTRACT

A cell phone including: a main body and a rotary element is provided. The main body has a first surface. The rotary element is installed to the main body, and includes a rotary portion. The rotary portion is located on the first surface, and the rotary portion has a function of rotating over the main body.

This application claims the benefit of Taiwan Patent Application No. 097223400, filed on Dec. 26, 2008, which is hereby incorporated by reference for all purposes as if fully set forth herein.

### BACKGROUND OF THE INVENTION

1. Field of Invention

The present invention relates to a communication device, and more particularly to a cell phone provided with an incoming call prompt.

2. Related Art

A cell phone is an electronic device for people to conveniently hold with hands and use for communication, such electronic devices include PDA cell phones or smart phones, and the like. When a user is in an inappropriate situation to answer an incoming call or the user does not want the cell phone to emit a ring tone, the user may set the incoming call prompt mode of the cell phone to a vibration mode to prevent disturbing surrounding people.

However, the high vibration frequency of the cell phones on the market cause the cell phone still emits an extremely large mechanical sound when receiving an incoming call. Therefore, surrounding people may be disturbed. However, if the vibration frequency is lowered, it will be difficult to attract the attention of the user and consequently an important call may be missed.

### SUMMARY OF THE INVENTION

An objective of the present invention is to provide a cell phone which is capable of reducing the ringtone volume of an incoming call and warns the user.

The present invention provides a cell phone. The cell phone includes a main body and a rotary element. The main body includes a first surface. The rotary element is installed in the main body, and includes a rotary portion. The rotary portion is located on the first surface, and the rotary portion has a function of rotating over the main body.

In an embodiment of the present invention, the main body further includes a camera lens located on the first surface, and the rotary portion is located near the camera lens.

In an embodiment of the present invention, the main body further includes a second surface and a screen. The second surface is located opposite to the first surface. The screen is located on the second surface.

In an embodiment of the present invention, the cell phone further includes at least one protruding piece fixedly on the rotary portion, wherein the rotary portion is located between the protruding piece and the main body.

In an embodiment of the present invention, the rotary portion is a disc, and the protruding piece is located near an edge of the disc.

In an embodiment of the present invention, the protruding piece and the rotary portion are formed as an integral unit.

In an embodiment of the present invention, the rotary portion rotates around a rotation axis over the main body, and the rotation axis is substantially perpendicular to the first surface.

In an embodiment of the present invention, the rotary portion is a disc.

In an embodiment of the present invention, the rotation axis is substantially at the center of the disc.

In an embodiment of the present invention, the rotary portion is a ring-shaped.

In an embodiment of the present invention, the rotation axis is substantially at the center of the rotary portion.

In an embodiment of the present invention, the main body further includes a camera lens located on the first surface, and the rotary portion surrounds the camera lens.

In an embodiment of the present invention, the rotary element further includes a power component installed in the main body, and the power component drives rotation of the rotary portion.

In an embodiment of the present invention, the main body has a circuit board electrically connected to the power component.

In an embodiment of the present invention, the power component is connected to the rotary portion.

In an embodiment of the present invention, the power component is a motor.

In an embodiment of the present invention, the main body has a communication module electrically connected to the rotary element, and when the communication module receives a signal representing an incoming call which has not yet been answered, the communication module enables the rotary portion to rotate.

In an embodiment of the present invention, when the cell phone answers the incoming call, then the communication module directs the rotary portion to stop rotating upon the incoming call being answered.

In an embodiment of the present invention, the main body has a circuit board, and the communication module is disposed on the circuit board and electrically connected to the rotary element through the circuit board.

The present invention uses rotating of a rotary portion to prompt the user to answer an incoming call. Compared to the prior art, the cell phone of the present invention is able to attract the attention of the user when receiving an incoming call while at the same time decreasing the sound produced by the cell phone, thereby reducing disturbance to surrounding persons or the environment.

To enable a further understanding of said objectives and the technological methods of the invention herein, a brief description of the drawings is provided below followed by a detailed description of the preferred embodiments.

### BRIEF DESCRIPTION OF THE DRAWINGS

The present invention will become more fully understood from the detailed description given herein below for illustration only, and which thus is not limitative of the present invention, and wherein:

FIG. 1A is an elevational bottom view depicting an embodiment of a cell phone of the present invention.

FIG. 1B is a cross-sectional view along the line I-I in FIG. 1A.

FIG. 1C is an elevational top view of the cell phone in FIG. 1A.

FIG. 2 is an elevational bottom view depicting another embodiment of a cell phone of the present invention.

### DETAILED DESCRIPTION OF THE INVENTION

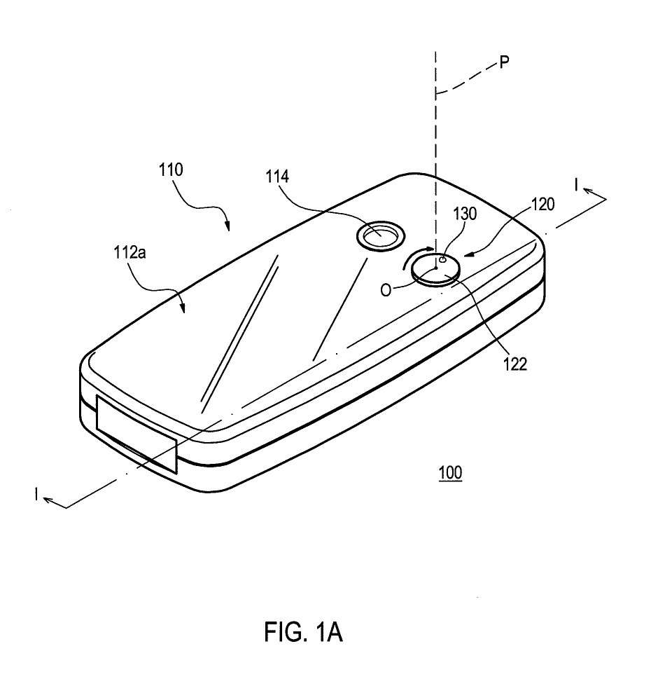

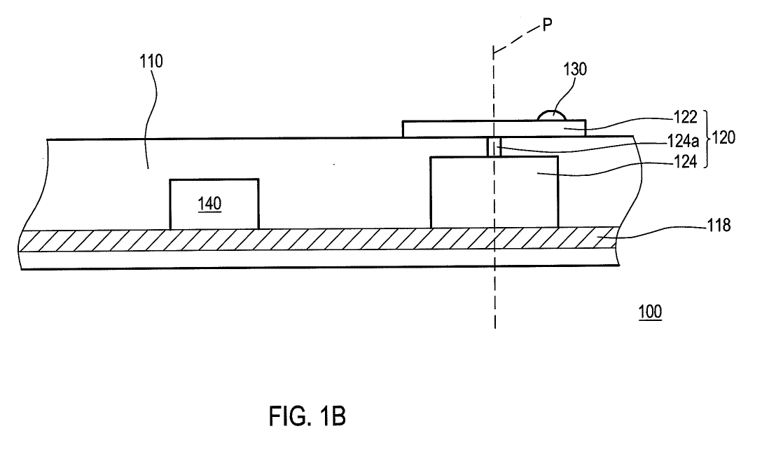

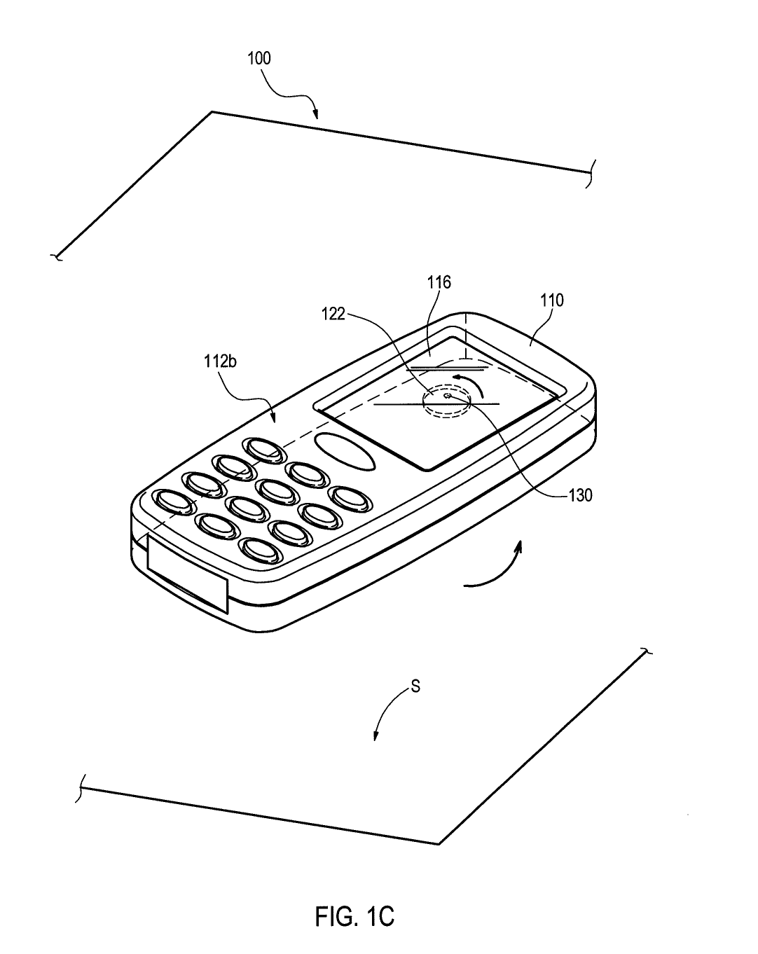

Refer to FIG. 1A, which shows an elevational bottom view depicting an embodiment of a cell phone according to the present invention. As depicted in FIG. 1A, an embodiment of a cell phone 100 comprises a main body 110 and a rotary element 120. The main body 110 has a first surface 112a, and the rotary element 120 is installed in the main body 110.

The rotary element 120 comprises a rotary portion 122. The rotary portion 122 is located on the first surface 112a and has a function of rotating over the main body 110. More specifically, the rotary portion 122 could be a disc. Besides, the rotary portion 122 has a function of rotating around a rotation axis P relative to the main body 110.

Carrying on from the above, the rotation axis P is substantially perpendicular to the first surface 112a; moreover, the rotation axis P is substantially at the center O of the disc. In other words, the rotary portion 122 has a function of rotating around the rotation axis P. From FIG. 1A it can be seen that the rotary portion 122 rotates clockwise around the rotation axis P. However, in other embodiments, the rotary portion 122 may rotate counterclockwise around the rotation axis P. That is, the rotation direction of the rotary portion 122 is not limited counterclockwise or clockwise.

In the present invention, the cell phone 100 has, but is not limited to, a photography function. More specifically, the main body 110 further has a camera lens 114. The camera lens 114 is located on the first surface 112a, thereby having both the camera lens 114 and the rotary portion 122 located on the same surface of the main body 110. Furthermore, the rotary portion 122 can be located near the camera lens 114.

FIG. 1B is a cross-sectional view along the line I-I of FIG. 1A. Refer to FIG. 1A and FIG. 1B, the rotary element 120 can further include a power component 124, which is, but is not limited to, a motor. The power component 124 is installed in the main body 110, and is able to drive rotation of the rotary portion 122. That is, the rotary portion 122 can automatically rotate by utilizing the power component 124.

The power component 124 is connected to the rotary portion 122. For example, when the power component 124 is a motor, the rotary portion 122 is directly installed onto a rotating shaft 124a of the power component 124, as depicted in FIG. 1B. However, the power component 124 may not need to directly connect to the rotary portion 122, but electronically connects to the rotary portion 122 so as to drive rotation of the rotary portion 122 according to a signal.

Carrying on from the above, more specifically, in other embodiments not depicted in the drawings, the power component 124 can be assembled with gears or belts, thereby enabling indirect driving rotation of the rotary portion 122 by the gears or the belts. In other words, the rotary element 120 depicted in FIG. 1B is only an exemplary example, and the present invention is not limited to such an example.

In addition, the cell phone 100 can further include one or a plurality of protruding pieces 130 fixedly on the rotary portion 122. In this embodiment, the cell phone 100 is illustrated with one protruding piece 130. The rotary portion 122 is located between the protruding piece 130 and the main body 110, as depicted in FIG. 1B. The protruding piece 130 is located near the edge of the rotary portion 122, that is, near the edge of the disc. When the rotary portion 122 is rotating, the protruding piece 130 is able to revolve around the rotation axis P.

Furthermore, the material of both the protruding piece 130 and the rotary portion 122 can be plastic or rubber, or other material with high friction force. Moreover, both the protruding piece 130 and the rotary portion 122 can be formed at the same time through injection molding means. Hence, the protruding piece 130 and the rotary portion 122 can be formed as an integral unit.

It is worth mentioning that the main body 110 further has a circuit board 118 and a communication module 140 electrically connected to the rotary element 120. The communication module 140 is disposed on the circuit board 118, and the communication module 140 is electronically connected to the rotary element 120 through the circuit board 118. The communication module 140 is capable of controlling rotation of the rotary portion 122. More specifically, when the cell phone 100 receives an incoming call, the communication module 140 receives a signal representing an incoming call. Accordingly, when the communication module 140 receives a signal representing an incoming call which has not yet been answered, that is, before the cell phone 100 enters a communication state, the communication module 140 transmits a control signal to the rotary element 120, which enables the rotary portion 122 to rotate.

When the cell phone 100 enters a communication state, the communication module 140 transmits another control signal to the rotary portion 122 to direct the rotary portion 122 to stop rotating upon the incoming call being answered. In other words, when the incoming call is answered, the communication module 140 directs the rotary portion 122 to stop rotating. Hence, it can be understood that the rotary portion 122 is rotating when the cell phone 100 receives an incoming call which has not yet been answered, and stops rotating upon the incoming call being answered.

The main body 110 further includes a processing module (not shown in the drawings) disposed on the circuit board 118 and electronically connected to the communication module 140 and the rotary element 120. The processing module is able to determine whether the communication module 140 has received a signal, or whether the cell phone 100 has entered a communication state. Further, the control signal is transmitted to the rotary element 120 to direct the rotary portion 122 to rotate or stop rotating.

FIG. 1C is an elevational top view of the cell phone in FIG. 1A. Referring to FIG. 1A and FIG. 1C, the main body 110 further has a second surface 112b and a screen 116. The second surface 112b is opposite to the first surface 112a, and the screen 116 is located on the second surface 112b. In other words, the screen 116 and the rotary portion 122 are respectively located on the two opposite surfaces of the main body 110.

Carrying on from the above, when the cell phone 100 is placed on a surface S with the screen 116 facing upwards (as depicted in FIG. 1C), then the protruding piece 130 contacts with the surface S. The surface S can be the ground, a tabletop, a floor, a cabinet or chair, and so on.

When the rotary portion 122 rotates, the main body 110 is driven to rise and fall because the protruding piece 130 rotates accompanying with the rotary portion 122. If the friction force between the protruding piece 130 and the surface S is high enough, the friction force will suppress rotation of the rotary portion 122. Consequently, the rotary element 120 directs the main body 110 to rotate in a reverse direction to that of the rotary portion 122. The friction force can be static friction force. Accordingly, when the rotary portion 122 rotates counterclockwise, the main body 110 rotates clockwise, as depicted in FIG. 1C, whereas, when the rotary portion 122 rotates clockwise, the main body 110 rotates counterclockwise.

Hence, it can be understood that when the cell phone 100 receives an incoming call, the rotary element 120 drives the main body 110 to produce a relative movement through the friction force between the protruding piece 130 and surface S, thereby attracting the attention of the user. Accordingly, when the cell phone 100 receives an incoming call, the abilities of the cell phone 100 are reinforced to prompt and attract the user of an incoming call.

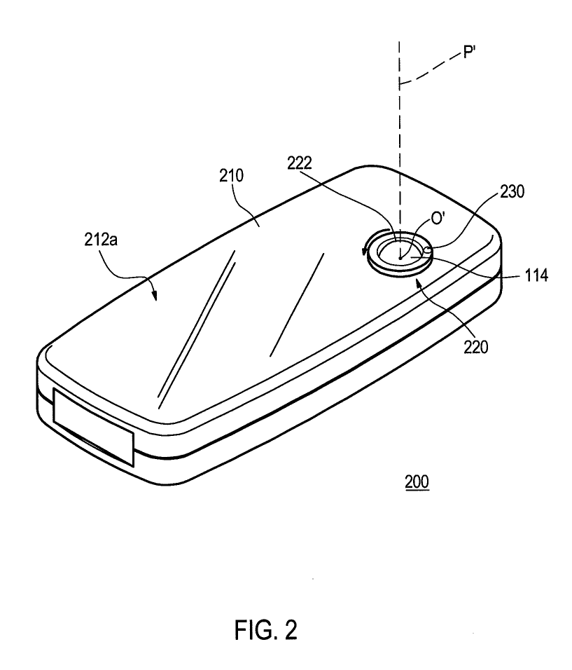

FIG. 2 is an elevational top view of another embodiment of a cell phone of the present invention. Refer to FIG. 2, the embodiment of the cell phone 200 is similar to the cell phone 100 of the aforementioned embodiment (see FIG. 1A). The difference between the cell phone 100 and the cell phone 200 lies in that the rotary portion 222 of the cell phone 200 is ring-shaped.

More specifically, the cell phone 200 comprises a main body 210 and a rotary element 220. The rotary element 220 comprises a rotary portion 222 which is of a ring-shape. One example of the ring-shape is a circular ring. In addition, the rotary portion 222 (that is, the ring-shape) can surround the camera lens (not depicted in FIG. 2) of the cell phone 200 Hence, the space occupied by the camera lens 114 and the rotary portion 222 is reduced, and the number of the components that can be installed to the cell phone 200 is increased.

Similar to the aforementioned embodiment, the rotary portion 222 also rotates around a rotation axis P′, and has a function of rotating over the main body 210 in clockwise or counterclockwise directions. The rotation axis P′ is substantially perpendicular to a first surface 212a of the main body 210. Moreover, the rotation axis P′ is substantially at the center of the rotary portion 222, that is, center O′ of a ring-shape.

Furthermore, in the embodiment, the cell phone 200 can further comprise one or a plurality of protruding pieces 230 fixedly on the rotary portion 222. In this embodiment, the cell phone 200 is illustrated with one protruding piece 130. Accordingly, when the rotary portion 222 is rotating, the protruding piece 230 is able to revolve around the rotation axis P′ in the clockwise or counterclockwise direction.

For specific description, effectiveness of this embodiment, method for the cell phone 200 to prompt the user of an incoming call, means of directing the rotary portion 222 to rotate and the timing for the rotary portion 222 to rotate are all basically the same as the aforementioned embodiment and thus the details thereof are not reiterated herein.

In conclusion, when a cell phone receives an incoming call, a rotary element of the embodiment rotates to prompt the user to answer the incoming call. Compared to the prior art, the cell phone of the present invention can attract more attention of the user when receiving an incoming call; therefore, the user may quickly pick up and answer the phone so as to reduce the ring sounds produced by the cell phone, thereby reducing disturbance to surrounding persons or the environment.

Furthermore, when the cell phone of the present invention is placed on a plane, such as ground, a tabletop, a floor, a cabinet or a chair, a friction force between the protruding piece and the surface of the aforementioned objects directs the rotary element to drive rotation of the main body or produce a relative movement.

Accordingly, when the cell phone receives an incoming call, the cell phone of the present invention is able to attract the attention of the user, thereby prompting the user to quickly answer the incoming call so as to reduce the ring sounds produced by the cell phone.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A cell phone, comprising:
a main body having a first surface; and
a rotary element installed in the main body and comprising a rotary portion, wherein the rotary portion is located on the first surface and has a function of rotating over the main body.

2. The cell phone according to claim 1, wherein the main body further comprises a camera lens located on the first surface, and the rotary portion is located near the camera lens.

3. The cell phone according to claim 1, wherein the main body further comprises a second surface opposite to the first surface and a screen located on the second surface.

4. The cell phone according to claim 1, further comprising at least one protruding piece fixed on the rotary portion, wherein the rotary portion is located between the protruding piece and the main body.

5. The cell phone according to claim 4, wherein the rotary portion is a disc, and the protruding piece is located near an edge of the disc.

6. The cell phone according to claim 4, wherein the protruding piece and the rotary portion are formed as an integral unit.

7. The cell phone according to claim 1, wherein the rotary portion rotates around a rotation axis over the main body and the rotation axis is substantially perpendicular to the first surface.

8. The cell phone according to claim 7, wherein the rotary portion is a disc.

9. The cell phone according to claim 8, wherein the rotation axis is substantially at the center of the disc.

10. The cell phone according to claim 7, wherein the rotary portion is ring-shaped.

11. The cell phone according to claim 10, wherein the rotation axis is substantially at the center of the rotary portion.

12. The cell phone according to claim 10, wherein the main body further comprises a camera lens located on the first surface, and the rotary portion surrounds the camera lens.

13. The cell phone according to claim 1, wherein the rotary element further comprises a power component installed in the main body, and the power component drives rotation of the rotary portion.

14. The cell phone according to claim 13, wherein the main body has a circuit board electrically connected to the power component.

15. The cell phone according to claim 13, wherein the power component is connected to the rotary portion.

16. The cell phone according to claim 13, wherein the power component is a motor.

17. The cell phone according to claim 1, wherein the main body has a communication module electrically connected to the rotary element, and when the communication module receives a signal representing an incoming call which has not yet been answered, the communication module enables the rotary portion to rotate.

18. The cell phone according to claim 17, wherein the communication module directs the rotary portion to stop rotating upon the incoming call being answered.

19. The cell phone according to claim 18, wherein the main body has a circuit board, and the communication module is disposed on the circuit board and electrically connected to the rotary element through the circuit board.
